(19) United States
(12) Patent Application Publication
(10) Pub. No.: US 2025/0045476 A1
(43) Pub. Date: Feb. 6, 2025

(54) METHOD FOR EVALUATING FATIGUE DAMAGE AND LIFE OF BRIDGE STRUCTURE UNDER MULTI-FACTOR COUPLING EFFECT AND COMPUTER-READABLE STORAGE MEDIUM

(71) Applicant: Southeast University, Jiangsu (CN)

(72) Inventors: Tong GUO, Jiangsu (CN); Zhongxiang LIU, Jiangsu (CN); Shiyuan WANG, Jiangsu (CN); Jie LIU, Jiangsu (CN)

(73) Assignee: Southeast University, Jiangsu (CN)

(21) Appl. No.: 18/709,030

(22) PCT Filed: Jul. 4, 2023
(86) PCT No.: PCT/CN2023/105667

§ 371 Date: May 10, 2024

(30) Foreign Application Priority Data
Aug. 22, 2022 (CN) 202211006077.0

(51) Int. Cl. G06F 30/13

(52) U.S. Cl. CPC G06F 30/13

(57) ABSTRACT

Disclosed is a method for evaluating the fatigue damage and life of a bridge structure under a multi-factor coupling effect. The method comprises the following steps: S1, reproducing complex service environment action values; S2, analyzing performance values of a bridge structure; S3, calculating coupling fatigue damage of a vulnerable part; and S4, predicting a remaining life of the bridge structure. By adopting the method, the fatigue damage condition and remaining life of an in-service bridge under a multi-factor coupling effect can be accurately evaluated, and the effect of each factor/action and the coupling effect the factors/actions in fatigue damage of a vulnerable part are quantitatively analyzed, thereby providing data support and decision-making reference for the operation and maintenance management, reinforcement and repair, and optimal design of bridges.

### TECHNICAL FIELD

The invention belongs to the field of hazard analysis and life evaluation of bridges under multiple factors, and relates to a method for evaluating the fatigue damage and life of a bridge structure under a multi-factor coupling effect.

### DESCRIPTION OF RELATED ART

Because of the complex service environment of a bridge structure, the bridge structure is affected by many factors including fatigue actions such as vehicle load, wind and temperature, a corrosive action and an abrasive action. Under a complex load-environment action, damage of a large-span bridge is generally caused by multiple factors/actions and the coupling effect thereof. These factors/actions are highly random in frequency and strength, different in distribution, and inconsistent in time phase and frequency, and the fatigue damage mechanism under the multi-factor action is uncertain and complex, making it difficult to evaluate the damage and life of the bridge structure. With the increase of the service life of the bridge structure, accidents caused by coupling fatigue damage of the bridge structure will occur more frequently, thereby severely threatening the operation and maintenance safety of bridges. Previous study mainly focuses on performance analysis and life evaluation of bridges under the action of a single factor such as the fatigue factor, the corrosion factor or the abrasion factor, and the performance and life of bridges under a multiple-factor action are evaluated by means of general coefficients or by integrating multiple factors/actions, leading to unreasonable and unreliable results. In order to provide effective support for operation and maintenance decision of bridges, a method for accurately evaluating the performance of bridge structures by comprehensively taking into account multiple factors/actions in a complex in-service environment needs to be established to study the fatigue damage catastrophe mechanism under a multi-factor coupling effect and analyze the influence law of each factor in a structure failure. Hence, the invention establishes a method for evaluating the fatigue damage and life of a bridge structure under a multi-factor coupling effect.

At present, structure evaluation methods taking into account multiple factors/actions include: a structural part crack propagation prediction method based on multi-factor fusion correction disclosed by Patent No. 201510225325.4, a structural part remaining life prediction method based on multi-factor fusion correction disclosed by Patent No. 201510247506.7, and a structural part remaining strength evaluation method based on multi-factor fusion correction disclosed by Patent No. 201710001052.4, which all take into account the fatigue life, stress concentration, stress distribution, manufacturing process, surface strength and other factors that have an influence on the damage state of structural parts. However, the effects of these factors are reflected by the influence of coefficients on stress and are not distinguished, and the influence of each factor needs to be converted into the influence on the stress. Patent No. 202111427626.7 discloses a structure safety analysis method based on a multi-factor comprehensive influence, where the finite element model can be adjusted by a load amplification coefficient, a material property reduction coefficient, a cross-section damage coefficient and a support change efficient so as to analyze the combined effects of multiple unfavorable factors, but this method neither involves a coupling fatigue model of a multi-factor competitive relation, nor involves the probability reliability and decrease rate integration technique of a dominant factor of the probability reliability. Patent No. 201811067793.3 discloses a method and system for evaluating the remaining life of a stay cable wire based on corrosion-fatigue factors, which are a test method and system, However, this method and system only take into account the corrosion factor and the fatigue factor, and the coupling action of the two factors is generally tested.

### BRIEF SUMMARY OF THE INVENTION

To evaluate the coupling fatigue damage and life of a bridge structure under a complex load-environment action, the invention provides a method for comprehensively, accurately and efficiently evaluating the fatigue damage and life of a vulnerable part of a bridge structure under a multi-factor coupling effect, which can be used for analyzing the fatigue damage condition of the bridge structure in a service environment and predicting the remaining life of the bridge structure, thereby providing support for maintenance decision, reinforcement implementation and optimal design of bridges.

The invention provides a method for evaluating the fatigue damage and life of a bridge structure under a multi-factor coupling effect, comprising the following steps:
S1, establishing a probability distribution model for vehicle, wind, temperature, corrosion, abrasion and other factor/action characterization parameters according to bridge service environment structure monitoring data, determining the number of samples according to proportions of a joint occurrence frequency and duration of factors/actions, and performing sampling to generate factor/action characterization parameter samples;
S2, establishing a whole-bridge finite element model including a vulnerable part according to bridge design drawings, a three-dimensional geometrical model, etc.; combining the factor/action characterization parameter samples generated in S1 according to the proportions of the joint occurrence frequency and duration and an action region to form a sample series; sequentially inputting the factor/action characterization parameter samples to the finite element model to analyze performance values of the bridge structure to obtain a stress time history of the vulnerable part; performing rain flow counting to obtain a distribution of an equivalent stress amplitude and a distribution of a number of cycles by calculation according to the stress time history;
S3, according to damage indicator and structure performance time-dependent reliability calculation formulas under a fatigue factor/action, a corrosion factor/action and an abrasion factor/action, respectively calculating structure performance reliability decrease rates under the fatigue action, the corrosion action and the abrasion action in a current calculation step; taking the factor with a maximum reliability decrease rate as a dominant factor in the current calculation step, calculating a reliability decrement in the current calculation step according to the reliability decrease rate of the dominant factor, that is, determining the reliability decrement in the current calculation step by a competition of the reliability decrease rates under the factors/actions, and obtaining a reliability in the current calculation step by subtracting the reliability decrement in the current calculation step from a reliability in a previous step, wherein a reliability in a first calculation step is an initial reliability; and
S4, calculating the reliability sequentially until the reliability in the current calculation step is not less than a critical reliability, so as to obtain a coupling fatigue life; otherwise, returning S3 to calculate the reliability again.

Further, according to the method provided by the invention, in S3, a structure performance reliability β_{F} under the fatigue action is calculated by:

$${β}_{F} ( t ) = \frac{{μ}_{ln Δ} + {μ}_{ln A} - ( m \cdot {μ}_{ln {S}_{eq}} - {μ}_{ln N ( t )} )}{\sqrt{ln [ ( 1 + {δ}_{Δ}^{2} ) ( 1 + {δ}_{A}^{2} ) ( 1 + {δ}_{{N}_{0}}^{2} ) ] + {m}^{2} ln ( 1 + {δ}_{{S}_{eq}}^{2} )}} \qquad ( 1 )$$

where, μₗₙₓ and σₗₙₓ are respectively a mean value and standard deviation of lnx and are calculated and determined according to μₓ and σₓ, wherein x denotes Δ, A, N(t), N₀ and S_{eq} in formula (1); Δ is a Miner critical damage accumulation indicator which can be described by a logarithmic normal distribution function, a mean value μ_{Δ} of Δ is 1.0, and a variable coefficient σₓ of Δ is 0.3; A is a fatigue detail indicator which is determined according to a detail type of the vulnerable part; N₀ is the number of cycles; S_{eq} is the equivalent stress amplitude, which is calculated by the following formula; N(t) is equal to 365×ADT×N₀×t, ADT is a daily traffic flow, and t is a time by year.

$${S}_{eq}^{m} = {[ \sum \frac{{n}_{i} {S}_{i}^{m}}{N} ]}^{\frac{1}{m}}$$

Where, m is an exponent which is generally set to 3; N is the number of cycles required for the occurrence of fatigue damage under the equivalent stress amplitude S_{eq}; nᵢ is an actual number of cycles under a stress amplitude Sᵢ.

Further, according to the method provided by the invention, in S3, a structure performance reliability β_{C} under the corrosion action is calculated by:

$${β}_{C} ( t ) = \frac{{μ}_{ac} - {μ}_{a ( t )}}{\sqrt{{σ}_{ac}^{2} + {σ}_{a ( t )}^{2}}} \qquad ( 2 )$$

where, μ_{ac} and σ_{ac} are respectively a mean value and a standard deviation of a corrosive damage critical indicator; a(t) is a corrosive damage indicator, which is calculated and determined by the following formula; μₐ₍ₜ₎ and σ₍ₜ₎ are a mean value and a standard deviation of the corrosive damage indicator.

$$a ( t ) = 0.5 \frac{α {( t - {t}_{0} )}^{β}}{d}$$

Where, α and β are parameters of a corrosive damage indicator calculation formula, denote a uniform corrosion rate and trend, are related to a metal type and a corrosion environment, and increase logarithmically in case of steel corrosion, wherein β=0.5; α follows a logarithmic normal distribution, and a mean value and a deviation factor of a are 7.91×10⁻⁶ m/year and 0.135 respectively; t₀ is an initial time; dis a corrosion direction of the vulnerable part.

Further, according to the method provided by the invention, in S3, a structure performance reliability β_{W} under the abrasion action is calculated by:

$${β}_{W} = \frac{{μ}_{V c} - {μ}_{V ( t )}}{\sqrt{{σ}_{Vc}^{2} + {σ}_{V ( t )}^{2}}} \qquad ( 3 )$$

where, μ_{Vc} and σ_{Vc} are a mean value and a standard deviation of an abrasive damage critical indicator; V(t) is an abrasive damage indicator, which is calculated by the following formula; μ_{V(t)} and σ_{V(t)} are a mean value and a standard deviation of the abrasive damage indicator.

$${V}_{w} ( t ) = \frac{k}{H} F \cdot 2 δ \cdot ADT \cdot {N}_{0} \cdot t$$

Where, k is a parameter of an abrasion depth propagation rate formula; H is hardness; F is a lateral force.

Further, according to the method provided by the invention, in S3, the dominant factor in each calculation step is the factor with the maximum reliability decrease rate, and the reliability decrement and reliability in the current calculation step are calculated by:

$$Δ {β}_{i} = max \{ {( \frac{d {β}_{F} ( t )}{dt} )}_{i} , {( \frac{d {β}_{C} ( t )}{dt} )}_{i} , {( \frac{d {β}_{W} ( t )}{dt} )}_{i} \} Δ t \qquad ( 4 )$$

$$β ( t ) = {β ( t )}_{i - 1} - Δ {β}_{i}$$

where, Δβᵢ is the reliability decrement in the current calculation step, Δt is a time increment by year; β(t)_{I} and β(t)ᵢ₋₁ are the reliability in the current calculation step and the reliability in the previous calculation step.

In another aspect, the invention provides a computer-readable storage medium, having a computer program stored therein, wherein when the computer program is executed by a processor, the steps of the method for evaluating the fatigue damage and life of a bridge structure under a multi-factor coupling effect are performed.

The method provided by the invention is used for accurately evaluating the fatigue damage and remaining life of an in-service bridge structure in a load environment, thereby providing a basis for damage analysis and detection, maintenance and reinforcement decision of the bridge structure.

Compared with the prior art, the invention has the following advantages:

1. Existing techniques focus on the effect of a single factor and take insufficient account of the combined effect of multiple factors, so the accuracy of evaluation results of the existing techniques still needs to be improved; the method for evaluating the fatigue damage and life of a bridge structure under a multi-factor coupling effect in the application takes into account the coupling effect of multiple factors and comprehensively and reasonably takes into account the influence of complex in-service environmental factors, thereby providing reasonable and reliable evaluation results.

2. Existing techniques analyze the effect of multiple factors by general coefficients or by combining multiple factors/actions, cannot quantitatively analyze the influence of each factor, and have the problem of repetitive calculation, so the rationality of existing methods needs to be further improved; the method for evaluating the fatigue damage and life of a bridge structure under a multi-factor coupling effect in the application calculates the reliability decrement according to the reliability decrease rate under a dominant factor in each calculation step and calculates the accumulation between steps to obtain a coupling fatigue damage model of the multi-factor competition relation of the reliability, thus realizing quantitative analysis of each factor, reasonable calculation of the coupling effect of multiple factors, and high calculation accuracy.

3. In the invention, the dominant factor and the change thereof are determined with reference to the reliability decrease rate, thus solving the problem of different characterizations of damage under different factors/actions, realizing unified determination of damage under different factors/actions, and achieving high adaptivity.

### BRIEF DESCRIPTION OF THE SEVERAL VIEWS OF THE DRAWINGS

FIG. 1 is a flow diagram of reproduction of vehicle, wind, temperature, corrosion and abrasion values monitored under a complex service environment action;

FIG. 2 is an illustrative diagram of a finite element model and a vulnerable part of a bridge structure;

FIG. 3 illustrates an equivalent stress amplitude;

FIG. 4 illustrates the number of cycles;

FIG. 5 illustrates reliability decrease rates in case of fatigue damage, abrasive damage and corrosive damage;

FIG. 6 is a flow diagram of a method for evaluating the fatigue damage and life of a bridge structure under a multi-factor coupling effect;

FIG. 7 is an evaluation diagram of the competition of reliability decrease rates, the time-dependent reliability and the life under the effect of various factors.

### DETAILED DESCRIPTION OF THE INVENTION

The invention will be further described below in conjunction with embodiments and accompanying drawings in the specification, with a bolted U-steel node as a vulnerable part.

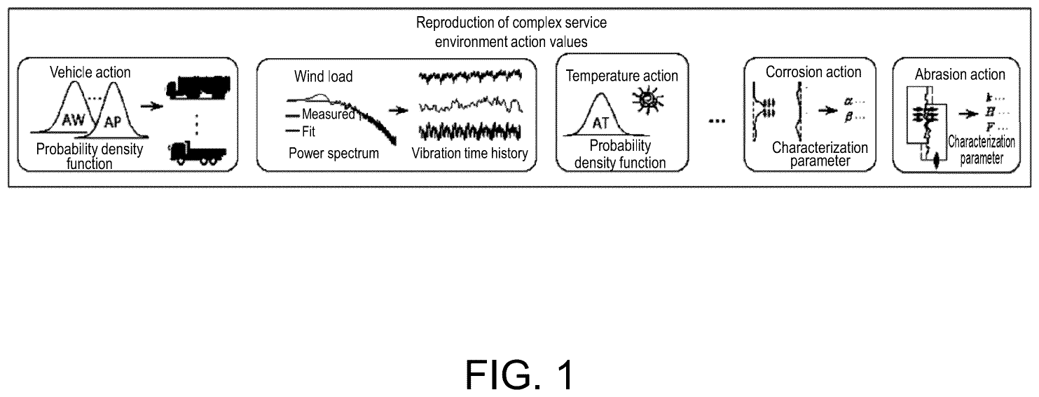

As shown in FIG. 1-FIG. 7, a method for evaluating the fatigue damage and life of a bridge structure under a multi-factor coupling effect comprises the following steps:

S1, a probability distribution model for vehicle, wind, temperature, corrosion, abrasion and other factor/action characterization parameters is established according to bridge service environment structure monitoring data, the number of samples is determined according to proportions of a joint occurrence frequency and duration of factors/actions, and sampling is performed to generate factor/action characterization parameter samples, as shown in FIG. 1.

The probability distribution model for the vehicle action characterization parameters comprises an axle weight probability distribution function, an axle base probability distribution function, a vehicle type and lane distribution proportion, etc., and is established based on analysis of a mobile weighing system, monitoring videos and other vehicle monitoring data. The wind action characterization parameters include the mean wind velocity per hour, the wind direction distribution proportion, etc., and are established based on measured wind load data. The temperature action characterization parameters include the mean daily temperature, the temperature gradient, etc., and are established based on monitored temperature data. The corrosion action characterization parameters include parameters α and β of a corrosive damage indicator calculation formula, and are established based on corrosion test measurement data, wherein α follows a logarithmic normal distribution, a mean value and a deviation factor of α are 7.91×10⁻⁶ m/year and 0.135 respectively, and β=0.5. The abrasion action characterization parameters include a parameter k of an abrasion depth propagation rate formula, hardness H, and a lateral force F, and are established based on abrasion test measurement data statistics, wherein k follows a logarithmic normal distribution, a mean value of k is 7×10⁻⁴, and a variable coefficient of k is 0.1.

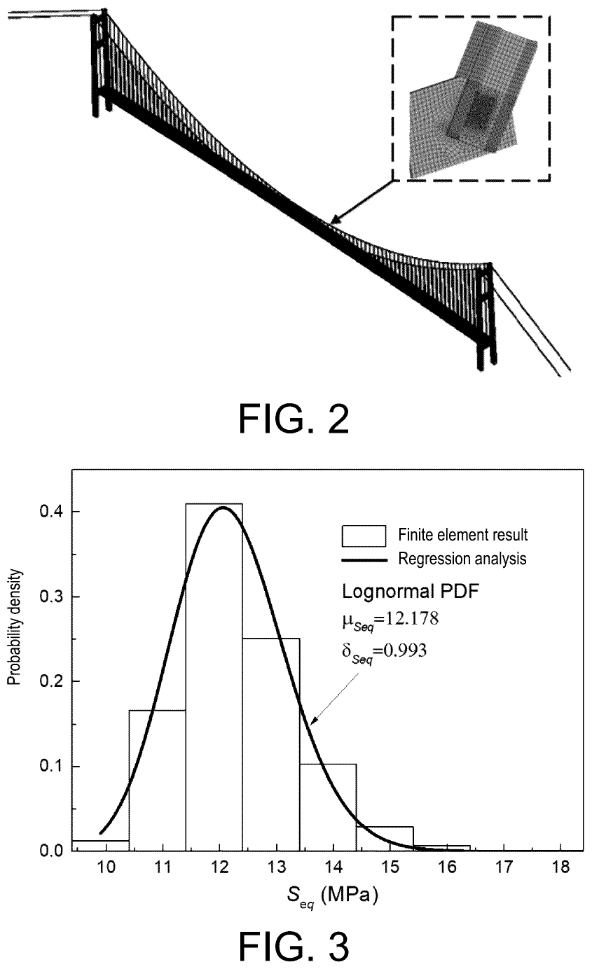

S2, a whole-bridge finite element model including a vulnerable part is established according to bridge design drawings, a three-dimensional geometrical model, etc., as shown in FIG. 2. A girder is simulated by a bridge unit, a main tower is simulated by a six-degree-of-freedom girder unit, and a cable is simulated by a three-degree-of-freedom rod unit which is only pulled and is not pressed. Material attributes are allocated to the corresponding units as specified. A bolted U-steel node is used as the vulnerable part by way of example, and the vulnerable part is partially refined according to partial geometric dimensions of the vulnerable part or a refined partial finite element model is established by the sub-model technique.

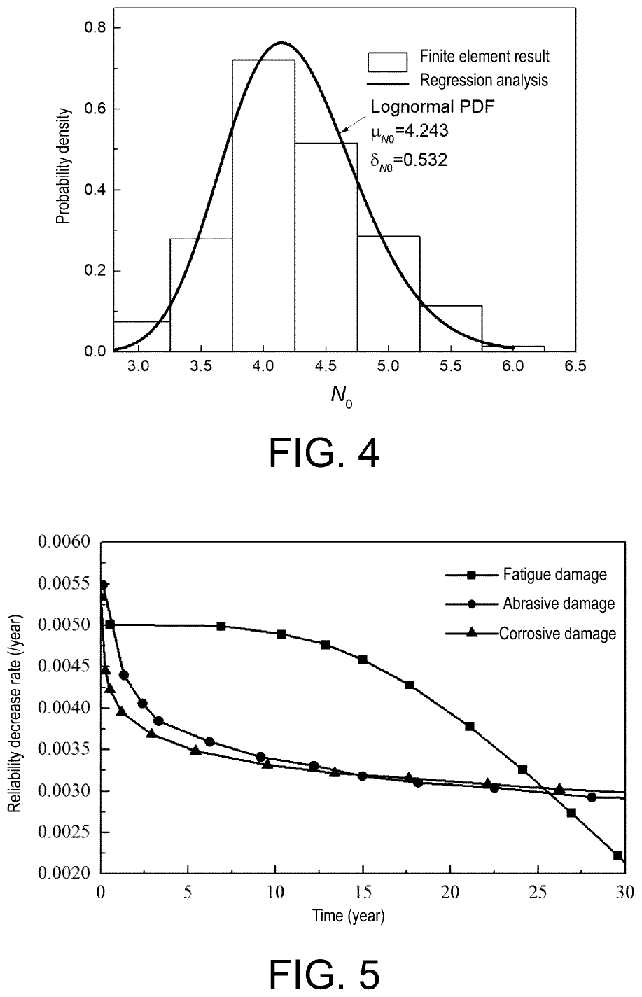

The factor/action characterization parameter samples generated in S1 are combined according to the proportions of the joint occurrence frequency and duration and an action region to form a sample series; the factor/action characterization parameter samples are sequentially input to the finite element model to analyze performance values of the bridge structure to obtain a stress time history of the vulnerable part; rain flow counting is performed to obtain a distribution of an equivalent stress amplitude and a distribution of a number of cycles by calculation according to the stress time history, and functions of the distribution of the equivalent stress amplitude and the distribution of the number of cycles are obtained by regression analysis fitting, as shown in FIG. 3 and FIG. 4.

S3, a structure performance reliability decrease rate in an i^{th} step under the fatigue action is calculated, and as shown in FIG. 5, a structure performance time-dependent reliability calculation formula under the fatigue action is as follows:

$${β}_{F} ( t ) = \frac{{μ}_{ln Δ} + {μ}_{ln A} - ( m \cdot {μ}_{ln {S}_{eq}} - {μ}_{ln N ( t )} )}{\sqrt{ln [ ( 1 + {δ}_{Δ}^{2} ) ( 1 + {δ}_{A}^{2} ) ( 1 + {δ}_{{N}_{0}}^{2} ) ] + {m}^{2} ln ( 1 + {δ}_{{S}_{eq}}^{2} )}} \qquad ( 1 )$$

where, μₗₙₓ and σₗₙₓ are respectively a mean value and standard deviation of lnx and are calculated and determined according to μₓ and σₓ, wherein x denotes Δ, A, N(t), N₀ and S_{eq} in formula (1); Δ is a Miner critical damage accumulation indicator which can be described by a logarithmic normal distribution function, a mean value μ_{Δ} of Δ is 1.0, and a variable coefficient σ_{Δ} of Δ is 0.3; A is a fatigue detail indicator which is determined according to a detail type of the vulnerable part; N₀ is the number of cycles; S_{eq} is the equivalent stress amplitude which is calculated by the following formula; N(t) is equal to 365×ADT×N₀×t, ADT is a daily traffic flow, and t is a time by year; m is an exponent which is generally set to 3.

A structure performance reliability decrease rate in the i^{th} step under the corrosion action is calculated, and as shown in FIG. 5, a structure performance time-dependent reliability calculation formulas under the corrosion action is as follows:

$${β}_{C} ( t ) = \frac{{μ}_{ac} - {μ}_{a ( t )}}{\sqrt{{σ}_{ac}^{2} + {σ}_{a ( t )}^{2}}} \qquad ( 2 )$$

where, μ_{ac} and σ_{ac} are respectively a mean value and a standard deviation of a corrosive damage critical indicator; a(t) is a corrosive damage indicator, which is calculated and determined by the following formula; μₐ₍ₜ₎ and σ₍ₜ₎ are a mean value and a standard deviation of the corrosive damage indicator.

$$a ( t ) = 0.5 \frac{{α ( t - {t}_{0} )}^{β}}{d}$$

Where, t₀ is an initial time; dis a corrosion direction of the vulnerable part.

A structure performance reliability decrease rate in the i^{th} step under the abrasion action is calculated, and as shown in FIG. 5, a structure performance time-dependent reliability calculation formulas under the abrasion action is as follows:

$${β}_{W} = \frac{{μ}_{Vc} - {μ}_{V ( t )}}{\sqrt{{σ}_{Vc}^{2} + {σ}_{V ( t )}^{2}}} \qquad ( 3 )$$

where, μ_{Vc} and σ_{Vc} are a mean value and a standard deviation of an abrasive damage critical indicator; V(t) is an abrasive damage indicator, which is calculated by the following formula; μ_{V(t)} and σ_{V(t)} are a mean value and a standard deviation of the abrasive damage indicator.

$${V}_{w} ( t ) = \frac{k}{H} F \cdot 2 δ \cdot ADT \cdot {N}_{0} \cdot t$$

Taking the factor with a maximum reliability decrease rate as a dominant factor in the i^{th} step, a reliability decrement Δβᵢ in the i^{th} step is calculated according to the reliability decrease rate of the dominant factor in the i^{th} step, that is, the reliability decrement Δβᵢ in the i^{th} step is determined by a competition of the reliability decrease rates under the factors/actions, and a reliability βᵢ in the i^{th} step is obtained by subtracting the reliability decrement Δβᵢ in the current calculation step from a reliability βᵢ in a (i−1)^{th} step, wherein the reliability in a first step is an initial reliability β₀=12.0. A specific calculation formula is as follows:

$$Δ {β}_{i} = max \{ {( \frac{d {β}_{F} ( t )}{dt} )}_{i} , {( \frac{d {β}_{C} ( t )}{dt} )}_{i} , {( \frac{d {β}_{W} ( t )}{dt} )}_{i} \} Δ t \qquad ( 4 )$$

$$β ( t ) = {β ( t )}_{i - {1}^{-}} Δ {β}_{i}$$

where, Δ βᵢ is the reliability decrement in the current calculation step, Δt is a time increment by year; β(t)_{I} and β(t)ᵢ₋₁ are the reliability in the current calculation step and the reliability in the previous calculation step.

S4, the reliability is calculated sequentially until the reliability in the current calculation step is not less than a critical reliability βₜₕ, so as to obtain a coupling fatigue life; otherwise, S3 is performed to calculate the reliability again. The critical reliability βₜₕ can be set to 0, indicating that the bridge structure is completely damaged and needs to be maintained or replaced.

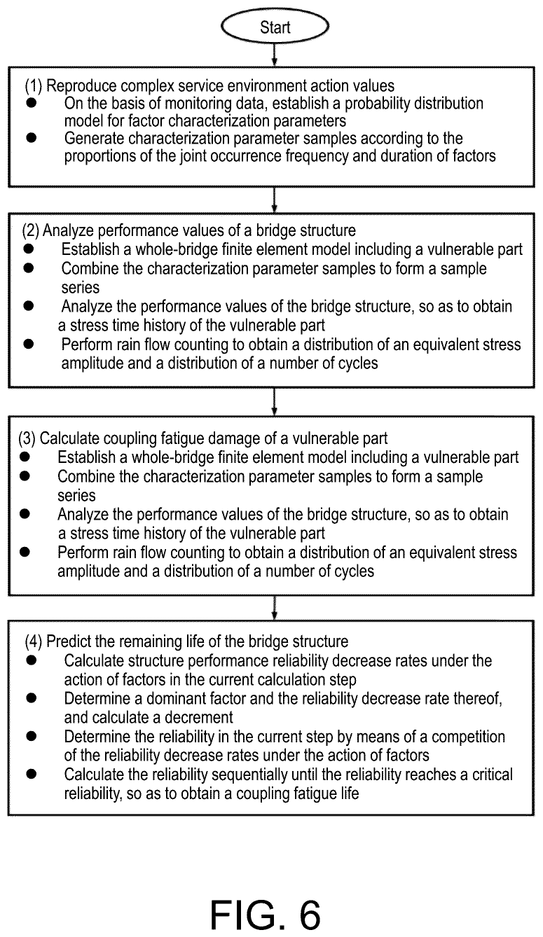

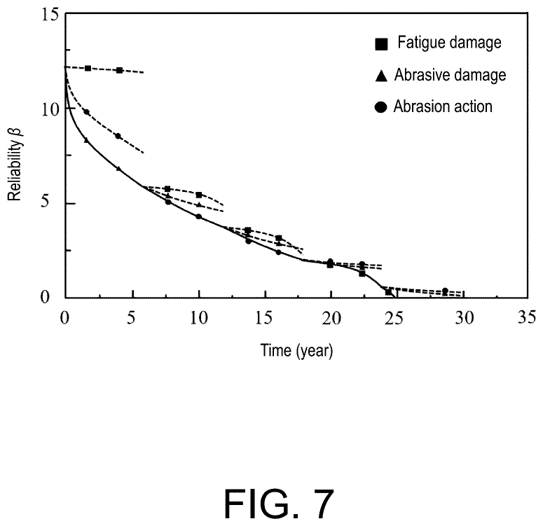

A flow diagram of the method for evaluating the fatigue damage and life of a bridge structure under a multi-factor coupling effect is shown in FIG. 6. The structure performance time-dependent reliability and coupling fatigue-damage remaining life calculated by the above flow under the fatigue, corrosion and abrasion actions are shown in FIG. 7. It can be known from FIG. 7 that the dominant factor may change in the service process, the structure performance reliability decreases continuously with time, and the fatigue-damage remaining life of the bolted U-steel node under a multi-factor coupling effect is about 24.8 years.

The above embodiments are merely preferred ones of the invention. It should be pointed out that those ordinarily skilled in the art can make some improvements and equivalent substitutions without departing from the principle of the invention, and technical solutions obtained based on these improvements and equivalent substitutions made to the claims of the invention should also fall within the protection scope of the invention.

What is claimed is:

1. A method for evaluating a fatigue damage and a life of a bridge structure under a multi-factor coupling effect, comprising the following steps:
S1, reproducing complex service environment action values;
S2, analyzing performance values of a bridge structure;
S3, calculating coupling fatigue damage of a vulnerable part; and
S4, predicting a remaining life of the bridge structure.

2. The method for evaluating the fatigue damage and the life of a bridge structure under a multi-factor coupling effect according to claim 1, wherein step S1 specifically comprises the following step: establishing a probability distribution model for factor/action characterization parameters according to a bridge service environment structure monitoring data, determining a number of samples according to proportions of a joint occurrence frequency and a duration of factors/actions, and performing sampling to generate factor/action characterization parameter samples.

3. The method for evaluating the fatigue damage and the life of the bridge structure under the multi-factor coupling effect according to claim 1, wherein step S2 specifically comprises the following steps: establishing a whole-bridge finite element model including the vulnerable part; combining the factor/action characterization parameter samples generated in step S1 according to the proportions of the joint occurrence frequency and the duration and an action region to form a sample series; sequentially inputting the factor/action characterization parameter samples to the whole-bridge finite element model to analyze the performance values of the bridge structure to obtain a stress time history of the vulnerable part; and performing rain flow counting to obtain a distribution of an equivalent stress amplitude and a distribution of a number of cycles by calculation according to the stress time history.

4. The method for evaluating the fatigue damage and the life of the bridge structure under the multi-factor coupling effect according to claim 1, wherein step S3 specifically comprises the following steps: according to damage indicator and structure performance time-dependent reliability calculation formulas under a fatigue factor/action, a corrosion factor/action and an abrasion factor/action, respectively calculating structure performance reliability decrease rates under a fatigue action, a corrosion action and an abrasion action in a current calculation step; and taking a factor with a maximum reliability decrease rate as a dominant factor in the current calculation step, calculating a reliability decrement in the current calculation step according to the reliability decrease rate of the dominant factor, that is, determining the reliability decrement in the current calculation step by a competition of the reliability decrease rates under the factors/actions, and obtaining a reliability in the current calculation step by subtracting the reliability decrement in the current calculation step from a reliability in a previous step, wherein a reliability in a first calculation step is an initial reliability.

5. The method for evaluating the fatigue damage and the life of the bridge structure under the multi-factor coupling effect according to claim 4, wherein in step S3, a structure performance reliability BF under the fatigue action is calculated by:
$${β}_{F} ( t ) = \frac{{μ}_{ln Δ} + {μ}_{ln A} - ( m \cdot {μ}_{ln {S}_{eq}} - {μ}_{ln N ( t )} )}{\sqrt{ln [ ( 1 + {δ}_{Δ}^{2} ) ( 1 + {δ}_{A}^{2} ) ( 1 + {δ}_{{N}_{0}}^{2} ) ] + {m}^{2} ln ( 1 + {δ}_{{S}_{eq}}^{2} )}} \qquad ( 1 )$$
where, μₗₙₓ and σₗₙₓ are respectively a mean value and standard deviation of lnx, wherein x denotes Δ, A, N(t), N₀ and S_{eq} in formula (1); Δ is a Miner critical damage accumulation indicator; A is a fatigue detail indicator; N₀ is the number of cycles; S_{eq} is the equivalent stress amplitude; N(t) is equal to 365×ADT×N₀×t, ADT is a daily traffic flow, and t is a time by year.

6. The method for evaluating the fatigue damage and the life of the bridge structure under the multi-factor coupling effect according to claim 5, wherein in step S3, a structure performance reliability β_{C} under the corrosion action is calculated by:
$${β}_{C} ( t ) = \frac{{μ}_{ac} - {μ}_{a ( t )}}{\sqrt{{σ}_{ac}^{2} + {σ}_{a ( t )}^{2}}} \qquad ( 2 )$$
where, μ_{ac} and σ_{ac} are a mean value and a standard deviation of a corrosive damage critical indicator; a(t) is a corrosive damage indicator; μₐ₍ₜ₎ and σ₍ₜ₎ are a mean value and a standard deviation of the corrosive damage indicator.

7. The method for evaluating the fatigue damage and the life of the bridge structure under the multi-factor coupling effect according to claim 6, wherein in step S3, a structure performance reliability β_{W} under the abrasion action is calculated by:
$${β}_{W} ( t ) = \frac{{μ}_{Vc} - {μ}_{V ( t )}}{\sqrt{{σ}_{Vc}^{2} + {σ}_{V ( t )}^{2}}} \qquad ( 3 )$$
where, μ_{Vc} and σ_{Vc} are a mean value and a standard deviation of an abrasive damage critical indicator; V(t) is an abrasive damage indicator; μ_{V(t)} and σ_{V(t)} are a mean value and a standard deviation of the abrasive damage indicator.

8. The method for evaluating the fatigue damage and the life of the bridge structure under the multi-factor coupling effect according to claim 7, wherein in step S3, the dominant factor in each of the calculation steps is the factor with the maximum reliability decrease rate, and the reliability decrement and the reliability in the current calculation step are calculated by:
$$Δ {β}_{i} = max \{ {( \frac{d {β}_{F} ( t )}{dt} )}_{i} , {( \frac{d {β}_{C} ( t )}{dt} )}_{i} , {( \frac{d {β}_{W} ( t )}{dt} )}_{i} \} Δ t \qquad ( 4 )$$
$$β ( t ) = {β ( t )}_{i - 1} - Δ {β}_{i}$$
where, Δβᵢ is the reliability decrement in the current calculation step, Δt is a time increment by year; β(t)_{I} and β(t)ᵢ₋₁ are the reliability in the current calculation step and the reliability in the previous calculation step.

9. The method for evaluating the fatigue damage and the life of the bridge structure under the multi-factor coupling effect according to claim 1, wherein step S4 specifically comprises the following steps: calculating a reliability sequentially until the reliability in the current calculation step is not less than a critical reliability, so as to obtain a coupling fatigue life; otherwise, returning S3 to calculate the reliability again.

10. A computer-readable storage medium, having a computer program stored in the computer-readable storage medium, wherein when the computer program is executed by a processor, the steps of the method for evaluating the fatigue damage and life of a bridge structure under a multi-factor coupling effect according to claim 1 is performed.
